(19) United States
(12) Patent Application Publication
(10) Pub. No.: US 2014/0312961 A1
(43) Pub. Date: Oct. 23, 2014

(54) SEMICONDUCTOR DEVICE COMPENSATING FOR NEGATIVE BIAS TEMPERATURE INSTABILITY EFFECTS AND RELATED METHODS OF OPERATION

(71) Applicant: SAMSUNG ELECTRONICS CO., LTD., SUWON-SI (KR)

(72) Inventor: YOUNGHUN SEO, HWASEONG-SI (KR)

(73) Assignee: SAMSUNG ELECTRONICS CO., LTD., SUWON-SI (KR)

(21) Appl. No.: 14/249,408

(22) Filed: Apr. 10, 2014

(30) Foreign Application Priority Data
Apr. 22, 2013 (KR) 10-2013-0044322

(51) Int. Cl. G05F 1/46

(52) U.S. Cl. CPC G05F 1/463
USPC 327/513

(57) ABSTRACT

A semiconductor device comprises a metal oxide semiconductor (MOS) transistor circuit configured to receive a body bias voltage, and a negative bias temperature instability compensation (NBTIC) circuit configured to measure a negative bias temperature instability level on the MOS transistor circuit using an operating timing variation measuring unit and to adaptively compensate for a bias according to the measured value.

### CROSS-REFERENCE TO RELATED APPLICATIONS

This application claims priority under 35 U.S.C. §119 to Korean Patent Application No. 10-2013-0044322 filed Apr. 22, 2013, the subject matter of which is hereby incorporated by reference.

### BACKGROUND OF THE INVENTION

The inventive concept relates generally to semiconductor devices, and more particularly, to semiconductor devices comprising a circuit compensating for Negative Bias Temperature Instability (NBTI) effects, and related methods of operation.

As semiconductor devices become increasingly integrated, they are subject to increasingly strict operating margins and are increasingly vulnerable to various forms of deterioration. Among these forms of deterioration are temperature effects. For example, in a PMOS transistor, during application of a negative gate voltage, a temperature increase can produce Negative Bias Temperature Instability (NBTI) effects that cause a decrease in an absolute value of a drain current, an increase in an absolute value of a threshold voltage and an increase in a Gate Induced Drain Leakage (GIDL) current.

If the negative voltage is applied to the gate of the PMOS transistor while its drain and source are grounded, a positive charge interface trap may be formed in a gate oxide film. Thus, the NBTI effects hinder formation of a channel, so that a threshold voltage of the PMOS transistor increases and an absolute value of its drain current decreases. Also, an energy band between the gate and the drain of the PMOS transistor may be bent by its gate voltage. In this case, because tunneling is easily generated, the GIDL current may increase.

NBTI may cause remarkable variation in a threshold voltage at a particular bias and high-temperature state, so it may pose a reliability problem of a high-speed semiconductor process. Accordingly, there is a general need for techniques to compensate for the NBTI effects in semiconductor devices such as dynamic random access memories.

### SUMMARY OF THE INVENTION

In one embodiment of the inventive concept, a semiconductor device comprises a MOS transistor circuit configured to receive a body bias voltage, and an NBTIC circuit configured to measure a negative bias temperature instability level on the MOS transistor circuit using an operating timing variation measuring unit and to adaptively compensate for a bias according to the measured value.

In another embodiment of the inventive concept, a method of compensating for negative bias temperature instability in a semiconductor device comprises receiving a first delay signal from a negative bias temperature instability free delay block, receiving a second delay signal from a negative bias temperature instability dependent delay block, comparing the first delay signal and the second delay signal to measure a level of negative bias temperature instability, and adaptively compensating for a body bias voltage on a transistor according to the measured level.

In yet another embodiment of the inventive concept, a method of compensating for negative bias temperature instability in a semiconductor device comprises comparing a first delay signal to a second delay signal to measure a level of negative bias temperature instability in the semiconductor device, and adaptively compensating for a body bias voltage of a transistor according to the measured level.

These and other embodiments of the inventive concept can potentially improve the reliability of semiconductor devices by decreasing their sensitivity to changes in temperature.

### BRIEF DESCRIPTION OF THE DRAWINGS

The drawings illustrate selected embodiments of the inventive concept. In the drawings, like reference numbers indicate like features.

FIG. 1 is a block diagram illustrating a memory system according to an embodiment of the inventive concept.

FIG. 2 is a cross-section view of a PMOS transistor, according to an embodiment of the inventive concept.

FIG. 3 is a block diagram illustrating a bias temperature instability compensating circuit illustrated in FIG. 1, according to an embodiment of the inventive concept.

FIG. 4 is a more detailed block diagram of the circuit in FIG. 3, according to an embodiment of the inventive concept.

FIG. 5 is a timing diagram illustrating the operation of the circuit of FIG. 4, according to an embodiment of the inventive concept.

FIG. 6 is a flowchart illustrating a method of controlling bias temperature instability compensation, according to an embodiment of the inventive concept.

FIG. 7 is a block diagram illustrating a variation of the circuit illustrated in FIG. 4, according to an embodiment of the inventive concept.

FIG. 8 is a block diagram illustrating a mobile devices, according to an embodiment of the inventive concept.

FIG. 9 is a block diagram illustrating a smart card, according to an embodiment of the inventive concept.

FIG. 10 is a block diagram illustrating a memory system, according to an embodiment of the inventive concept.

FIG. 11 is a block diagram illustrating a memory card, according to an embodiment of the inventive concept.

FIG. 12 is a block diagram illustrating an information processing system, according to an embodiment of the inventive concept.

FIG. 13 is a block diagram illustrating a solid state drive, according to an embodiment of the inventive concept.

FIG. 14 is a block diagram illustrating a computing system, according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms “first”, “second”, “third”, etc., may be used to describe various elements, components, regions, layers and/or sections, these elements, components, regions, layers and/or sections should not be limited by these terms. These terms, however, are used merely to distinguish one element, component, region, layer or section from another region, layer or section. Thus, a first element, component, region, layer or section discussed below could alternatively be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to encompass the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

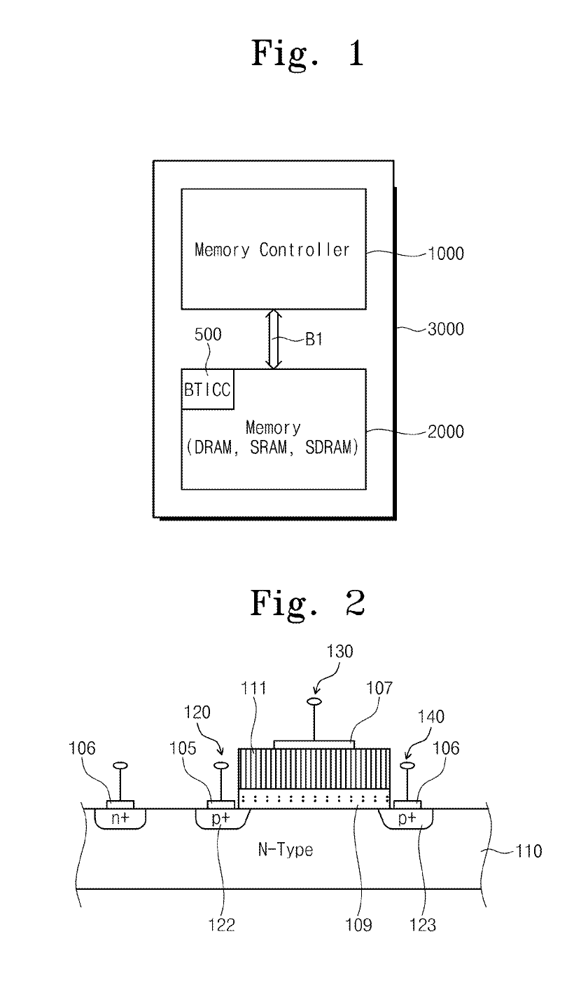

FIG. 1 is a block diagram illustrating a memory system according to an embodiment of the inventive concept.

Referring to FIG. 1, a memory system 3000 comprises a memory controller 1000 and a memory 2000. Memory 2000 is connected to memory controller 1000 through a bus B1. Bus B1 may be a bus for transferring an address, data, and a command.

Memory 2000 comprises a bias temperature instability compensation circuit 500 (marked by ‘BTICC’ in FIG. 1). Bias temperature instability compensation circuit 500 measures a level of bias temperature instability using an operating timing variation measuring unit and adaptively performs bias compensation according to the measured value.

Where bias temperature instability compensation circuit 500 compensates for negative bias temperature instability of a PMOS transistor, it may function as a negative bias temperature instability compensating (NBTICC) circuit. For adaptive NBTI compensation, bias temperature instability compensation circuit 500 is activated at a power-up operation of memory 200. Also, bias temperature instability compensation circuit 500 is periodically driven during a normal operation.

Bias temperature instability compensation circuit 500 is available when a device comprises a CMOS circuit. Thus, memory 2000 may be implemented by a nonvolatile semiconductor memory (e.g., a flash memory, etc.) as well as a volatile semiconductor memory (e.g., a DRAM, an SRAM, an SDRAM, etc.).

FIG. 2 is a cross-section view of a PMOS transistor, according to an embodiment of the inventive concept.

Referring to FIG. 2, the illustrated PMOS transistor comprises p-type wells 122 and 123 formed in an N-type substrate 110 and a gate 111. The p-type wells 122 and 123 are used as a source and a drain, respectively. Gate 111 formed on a gate insulation film 109 receives a gate voltage 130 through a gate electrode 107. Source 122 receives a source voltage 120 through a source electrode 105, and drain 123 receives a drain voltage 140 through a drain electrode 106. A body voltage is applied to an N-type well through a body electrode 106. The body voltage can be directly applied to N-type substrate 110.

Where drain 123 and source 122 are grounded and a negative voltage is applied to gate 111, a positive charge interface trap is formed in gate insulation film 109. The positive charge interface trap hinders formation of a channel, so that a threshold voltage of the PMOS transistor is decreased. Thus, an absolute value of its drain current is decreased, and an energy band between the gate and the drain of the PMOS transistor is bent by its gate voltage. In this case, because tunneling is easily generated, a GIDL current may increase.

Internal circuitry of a semiconductor device may predominantly comprise CMOS circuits, and extended use of the semiconductor device may produce NBTI effects. A general approach for compensating the NTBI effects is to measure a shift of an operating speed or threshold voltage of a transistor after performing a test operation under an accelerated condition. The NTBI effects are compensated by forward biasing a body voltage according to the measured value. However, with this approach, it is difficult to compensate for the NBTI effects additionally generated during an operation of the semiconductor device.

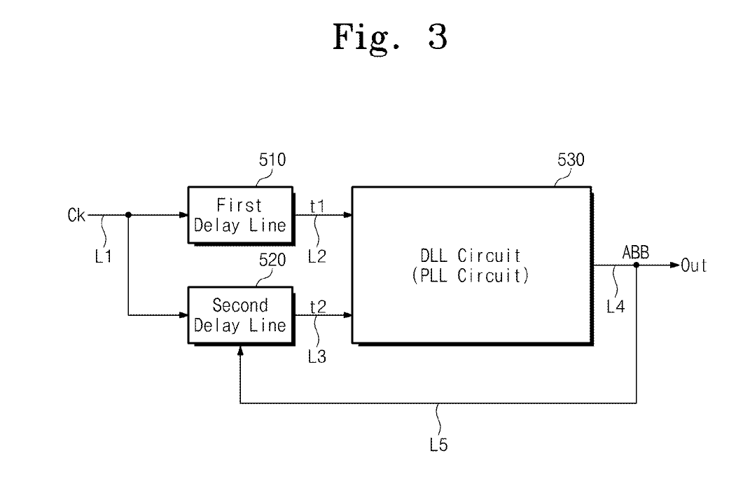

In certain embodiments of the inventive concept, a circuit structure illustrated in FIG. 3 is provided to adaptively compensate for the NBTI effects by deterioration of a transistor element during an operation of a semiconductor device.

FIG. 3 is a block diagram illustrating a bias temperature instability compensating circuit illustrated in FIG. 1, according to an embodiment of the inventive concept.

Referring to FIG. 3, an NBTI compensation circuit comprises a first delay line 510, a second delay line 520, and a DLL circuit 530.

First delay line 510 generates a first delay clock t1, and is driven by a reference body bias. First delay line 510 is a delay line that is insensitive to negative bias temperature instability. First delay line 510 delays a clock CK applied through a line L1 according to the reference body bias to generate first delay clock t1 on a line L2.

Second delay line 520 generates a second delay clock t2, and is driven by a feedback body bias. Second delay line 520 is a delay line that is sensitive to the negative bias temperature instability. Second delay line 520 delays clock CK according to the feedback body bias to generate second delay clock t2 on a line L3.

As a timing variation measurement unit, DLL circuit 530 compares a phase of first delay clock t1 with a phase of second delay clock t2 and compensates for a body bias voltage ABB according to the comparison result. Body bias voltage ABB is output through a line L4, and is fed back to second delay line 520 through a line L5.

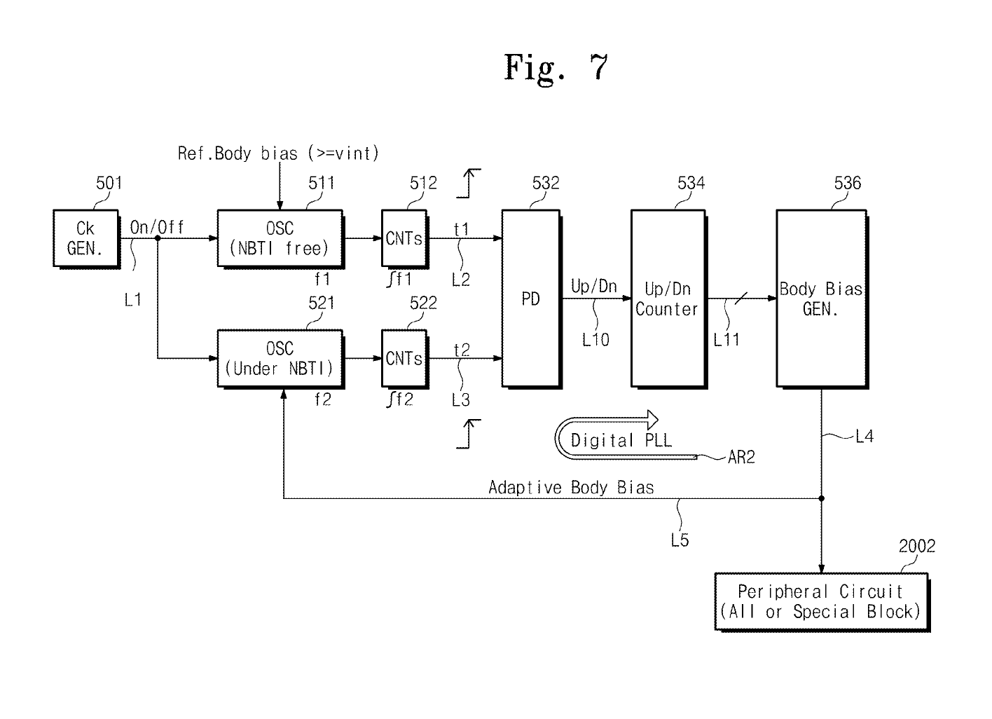

DLL circuit 530 may be replaced with a PLL circuit illustrated in FIG. 7 as another embodiment of the operating timing variation measuring unit.

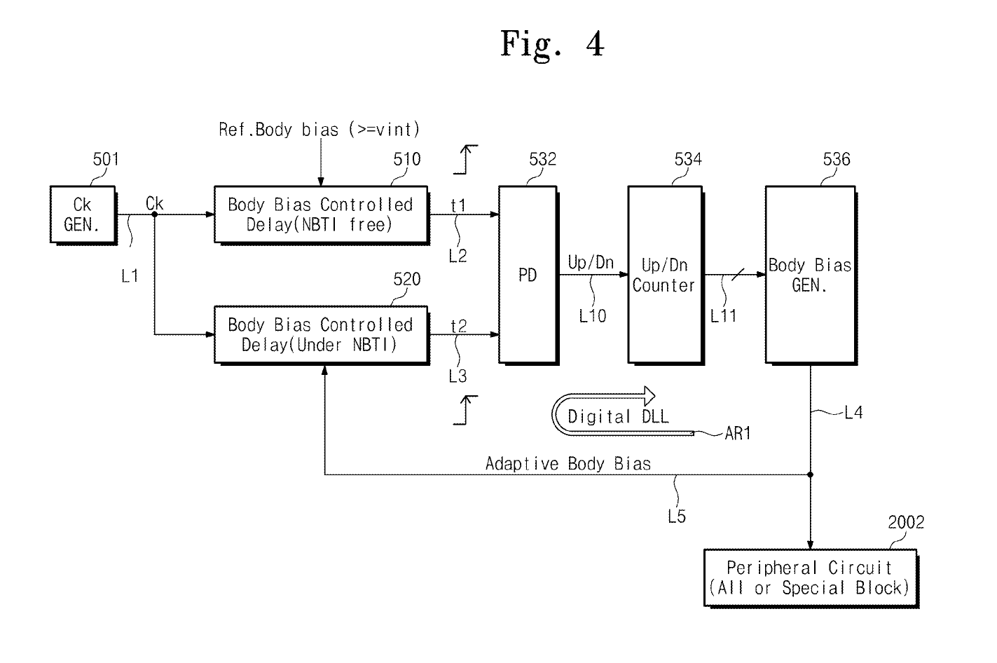

FIG. 4 is a more detailed block diagram of the circuit in FIG. 3, according to an embodiment of the inventive concept.

Referring to FIG. 4, in addition to the features shown in FIG. 3, DLL circuit 530 comprises a phase detector 532, an up-down counter 534, and a body bias generator 536. Phase detector 532 detects a difference between a phase of a first delay clock t1 applied through a line L2 and a phase of a second delay clock t2 applied through a line L3. Up-down counter 534 receives a detection output value from phase detector 532 through a line L10 and performs an up counting operation or a down counting operation according to the detection output value.

Body bias generator 536 receives an up-down counting signal from up-down counter 534 through a line L11 and generates a body bias voltage to be applied to a body of a MOS transistor according to the up-down counting signal. The body bias voltage of body bias generator 536 that experiences NBTI compensation is provided to a peripheral circuit 2002 or the whole chip or to a specific circuit block through an output line L4. Also, the body bias voltage is fed back to a body bias controlled delay functioning as second delay line 520, through a line L5.

Second delay line 520 is a delay line based on the NBTI effects. Second delay line 520 is always activated during an operation of a semiconductor device so as to be based on the NBTI effects. That is, when a MOS transistor in the semiconductor device is deteriorated, a MOS transistor in second delay line 520 is also deteriorated together.

A body bias controlled delay functioning as first delay line 510 is not based on the NBTI effects and is an NBTI-free delay line. Second delay line 520 is always inactivated during an operation of the semiconductor device so as not to be based on the NBTI effects. That is, first delay line 510 is activated only in a mode where the NBTI compensation operation is performed. Thus, although a MOS transistor in the semiconductor device is deteriorated, a MOS transistor in body bias controlled delay 510 is not deteriorated.

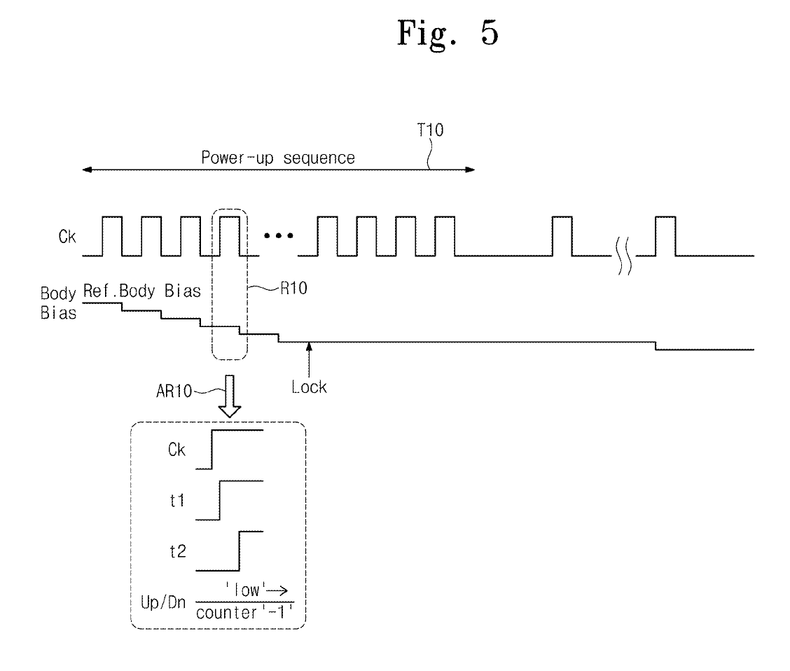

A clock generator 501 generates a clock signal of a predetermined frequency as illustrated in FIG. 5.

FIG. 5 is a timing diagram illustrating the operation of the circuit of FIG. 4, according to an embodiment of the inventive concept. More particularly, FIG. 5 illustrates a voltage level of a body bias locked by a DLL circuit during a power-up sequence period T10.

Referring to FIG. 5, a clock CK illustrated according to an arrow AR10 of a timing portion R10 illustrated in FIG. 5 is a clock CK output from a clock generator 501 illustrated in FIG. 4. Clock CK is used as a reference clock. If a body bias controlled delay 510 illustrated in FIG. 4 generates a first delay clock t1 as illustrated in FIG. 5 and a second delay line 520 generates a second delay clock t2, a phase of first delay clock t1 precedes that of second delay clock t2.

Here, body bias controlled delay 510 is a first delay line and is used as a reference delay line. That is, the first delay line is designed to escape an accelerated condition capable of generating NBTI and receives a reference body bias through a body of a PMOS transistor. Therefore, the first delay line always has a constant delay.

Second delay line 520 is a second delay line. Like a portion or all of a peripheral circuit, a delay of second delay line 520 is increased at generation of NBTI deterioration under an accelerated condition.

In the example of FIG. 5, an output of a phase detector 532 is set to a low level before DLL locking. That is, a detection output value of phase detector 532 may be a down (dn) signal. Thus, an up-down counter 534 performs a down counting operation such that an up-down counting value is decreased by ‘t1’. The down counting operation performed whenever clock CK is applied is continuously performed until an output of phase detector 532 transitions from a low level to a high level. Where an output of phase detector 532 transitions from a low level to a high level, that is, at DLL locking, a body bias maintains a level of a locked portion illustrated in FIG. 5.

Where a counting output value of up-down counter 534 is increased, a voltage level of the body bias becomes higher. Where a counting output value of up-down counter 534 is decreased, a voltage level of the body bias becomes lower. As a body bias voltage compensated as described above is applied to peripheral circuit 2002 of a semiconductor device, an operating speed of a chip may be constant regardless of generation of the NBTI effects.

As illustrated in FIG. 5, the circuit illustrated in FIG. 4 operates to maintain a ‘lock’ state through a DLL operation when phase detector 532 continues to output ‘low(dn)’ and then outputs ‘high(up)’. Where DLL operation is locked, degradation of a PMOS transistor due to the NBTI effects is compensated. The circuit illustrated in FIG. 4 periodically operates after power-up. As a result, the NBTI characteristic varied during an operation is adaptively tracked by the DLL.

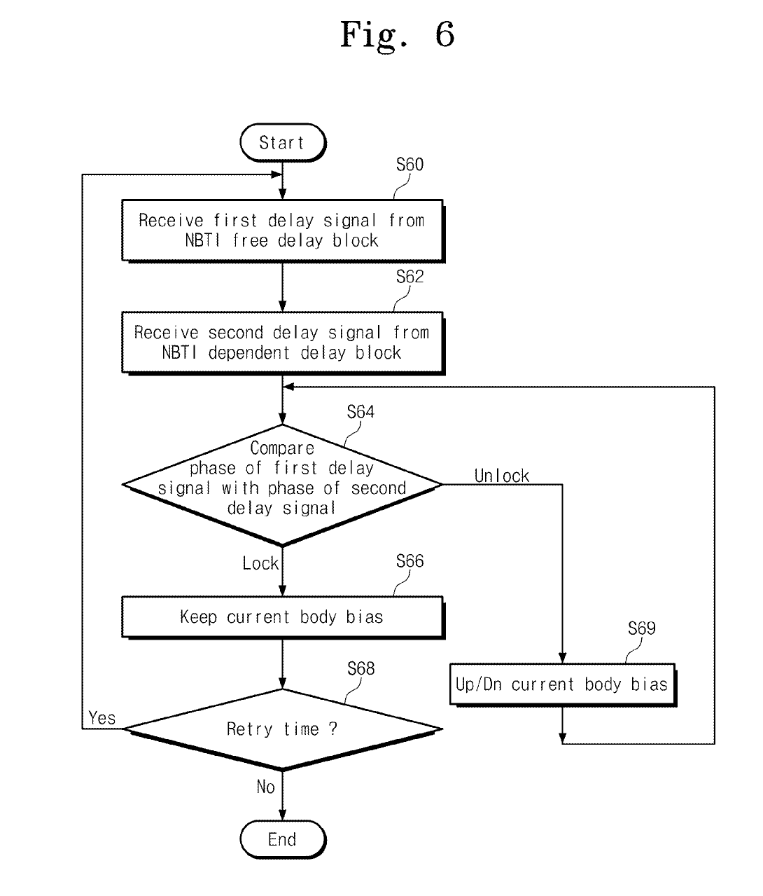

FIG. 6 is a flowchart of bias temperature instability compensation according to an embodiment of the inventive concept.

Referring to FIG. 6, in step S60, an NBTI compensation circuit receives a first delay signal from first delay line 510. In step S62, the negative bias temperature instability compensation circuit receives a second delay signal from second delay line 520.

In step S64, the negative bias temperature instability compensation circuit compares the first delay signal and the second delay signal to measure a level of negative bias temperature instability. That is, in step S64, whether a DLL circuit activated is locked or unlocked is checked. A locking operation is completed when a counting value of an up-down counter transitions from a decreasing direction to an increasing direction or from an increasing direction to a decreasing direction.

When locked, in step S66, a current body bias is maintained. When unlocked, in step S69, a voltage level of the current body bias is increased or decreased according to the counting value. In step S68, whether a retry time arrives is checked. Because a MOS transistor is degraded during an operation of a semiconductor device, the compensation operation need be periodically performed during an operation of the semiconductor device.

As understood from the above description, the NBTI effects generated during an operation of a semiconductor device are prevented or reduced by measuring a level of negative bias temperature instability and adaptively compensating for a body bias voltage on a PMOS transistor based on the measured level.

FIG. 7 is a block diagram illustrating a variation the circuit of FIG. 4, according to an embodiment of the inventive concept.

Referring to FIG. 7, the illustrated circuit varies from FIG. 4 in that it comprises a digital PLL. A clock generator 501 generates an on-off clock of a predetermined frequency through a line L1. A first oscillator 511 and a first integrator 512 may correspond to a first delay line 510 illustrated in FIG. 3.

First oscillator 511 is free from NBTI effects and receives a reference body bias voltage as a body bias voltage of a PMOS transistor in an internal circuit. First oscillator 511 outputs an output signal fl of a constant frequency. First integrator 512 integrates the output signal fl to output a first delay clock t1 on a line L2.

A second oscillator 521 and a second integrator 522 correspond to second delay line 520 illustrated in FIG. 3. Second oscillator 521 is dependent on the NBTI effects and receives an adaptive body bias voltage through a feedback line L5. Second oscillator 521 outputs an output signal f2 the frequency of which is variable according to a body bias voltage. Second integrator 522 integrates the output signal f2 to output a second delay clock t2 on a line L3.

A PLL circuit 530 comprises a phase detector 532, an up-down counter 534, and a body bias generator 536. Phase detector 532 detects a difference between a phase of first delay clock t1 applied through the line L2 and a phase of second delay clock t2 applied through the line L3.

Up-down counter 534 receives a detection output value from phase detector 532 through a line L10 and performs an up counting operation or a down counting operation according to the detection output value.

Body bias generator 536 receives an up-down counting signal from up-down counter 534 through a line L11 and generates a body bias voltage to be applied to a body of a MOS transistor according to the up-down counting signal. The body bias voltage of body bias generator 536 that experiences NBTI compensation is provided to peripheral circuit 2002 or the whole chip or to a specific circuit block through an output line L4. Also, the body bias voltage is fed back to a second delay line 520, functioning as a second delay line, through a line L5.

In FIG. 7, a body bias voltage of a PMOS transistor is inversely proportional to an output frequency of a second oscillator 521. Thus, it is possible to compensate for degradation due to the NBTI effects.

First and second integrators 512 and 522 may be implemented by a counter array. Two counter arrays may count the same clock in response to their inputs. For example, in event that 512 counting operations are performed, a ‘t1’ output goes to ‘High’ when a clock of an output fl is received 512 times and a ‘t2’ output goes to ‘High’ when a clock of an output f2 is received 512 times. A resolution may be improved in proportion to an increase in the number of counting operations of a counter.

Phase detector 532 compares the ‘t1’ output and the ‘t2’ output to determine a higher one of output frequencies of oscillators 511 and 521. The negative bias temperature instability may cause a threshold voltage shift of a PMOS transistor in a sense amplifier of a semiconductor memory. The NBTI drift may cause an increase in an offset of the sense amplifier by lapse of time and inaccurate sensing for hours. Thus, where a circuit is implemented as illustrated in FIG. 4 or FIG. 7, the NBTI effects are prevented or reduced. Thus, an operating speed of a semiconductor memory is maintained without lowering and an operating reliability is improved.

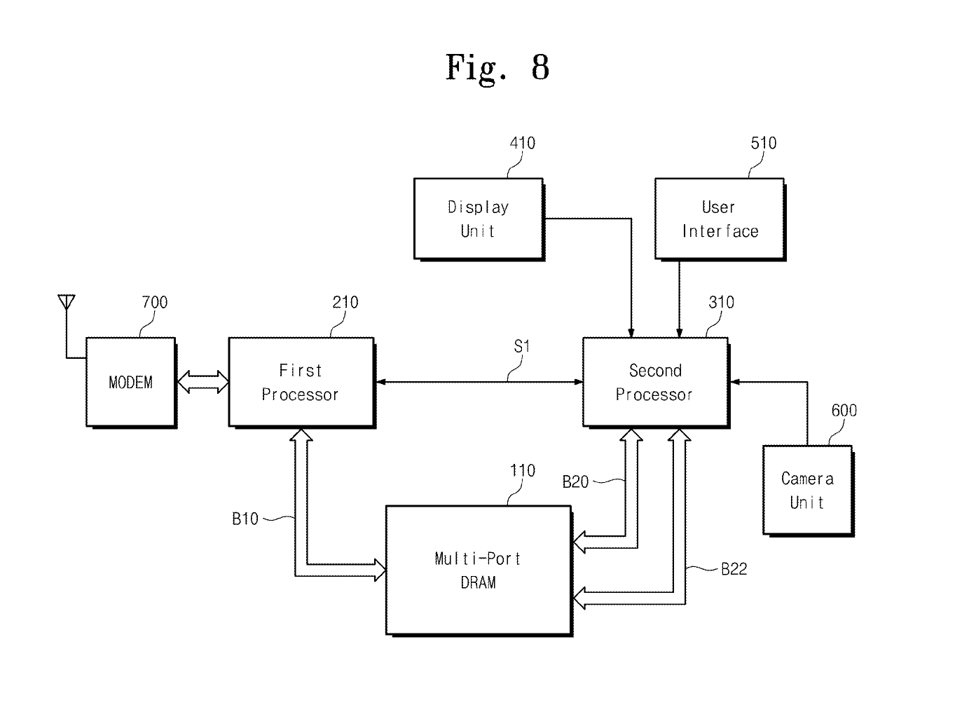

FIG. 8 is a block diagram illustrating a mobile device, according to an embodiment of the inventive concept.

Referring to FIG. 8, a mobile device (e.g., a smart phone) comprises a multi-port DRAM 110, a first processor 210, a second processor 310, a display unit 410, a user interface 510, a camera unit 600, and a modem 700.

Multi-port DRAM 110 comprises three ports connected to first, second, and third buses B10, B20, and B22, and is connected to first and second processors 210 and 310. A first port of multi-port DRAM 110 is connected to first processor 210 being a baseband processor through the first bus B10, and a second port thereof is connected to second processor 310 being an application processor through the second bus B20. Also, a third port of multi-port DRAM 110 is connected to second processor 310 through the third bus B22.

Thus, one multi-port DRAM 110 may be a memory device that replaces a storage memory and two DRAMs. Multi-port DRAM 110 may comprise a negative bias temperature instability compensation circuit illustrated in FIG. 3.

Multi-port DRAM 110 of FIG. 8 may comprise three ports and perform roles of a DRAM and a flash memory. In this case, multi-port DRAM 110 compensates for negative bias temperature instability effects. Thus, a performance of the mobile device is improved and a circuit is simple. An interface of the first bus B10 and an interface of the third bus B22 may be a volatile memory interface such as a DRAM interface.

An interface of the second bus B20 may be a nonvolatile memory interface such as a NAND flash interface. In some cases, first and second processors 210 and 310 and multi-port DRAM 110 may be integrated or packaged in a chip. In this case, multi-port DRAM 110 may be embedded in the mobile device.

Where the mobile device is a handheld communications device, first processor 210 may be connected to modem 700 that transmits and receives communications data and modulates and demodulates data. A NOR or NAND flash memory may be additionally connected to first processor 210 or second processor 310 to store mass information.

Display unit 400 has a liquid crystal having a backlight, a liquid crystal having an LED light source, or a touch screen (e.g., OLED). Display unit 400 may be an output device for displaying images (e.g., characters, numbers, pictures, etc.) in color.

In the above example the mobile device is a mobile communications device. In some instances, the mobile device may be used as a smart card by adding or removing components. The mobile device may be connected to an external communications device through a separate interface. The communications device may be a DVD player, a computer, a set top box (STB), a game machine, a digital camcorder, or the like.

Camera unit 600 may comprise a camera image processor (CIS), and is connected to second processor 300. Although not shown in FIG. 8, the mobile device may further comprise an application chipset, a camera image processor (CIS), a mobile DRAM, and so on.

A multi-port DRAM 110 or a flash memory chip capable of being additionally connected may be mounted independently or using various packages. For example, a chip may be packed by a package such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), or the like.

FIG. 9 is a block diagram illustrating a smart card, according to an embodiment of the inventive concept.

Referring to FIG. 9, a smart card 10 comprises a memory controller 14 and a DRAM 12. DRAM 12 comprises a negative bias temperature instability compensation circuit illustrated in FIG. 3. In smart card 10, it is possible to prevent or reduce negative bias temperature instability effects.

Memory controller 14 writes data needed for smart card 10 in a selected memory cell of DRAM 12. In response to an input of a read command from memory controller 14, DRAM 12 reads data stored in a selected memory cell.

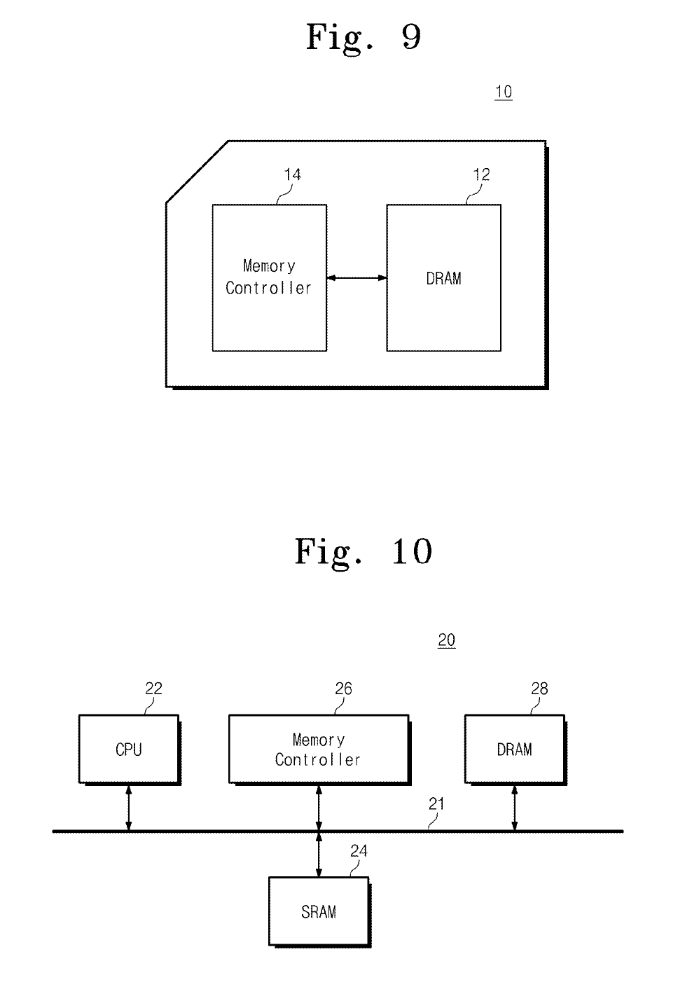

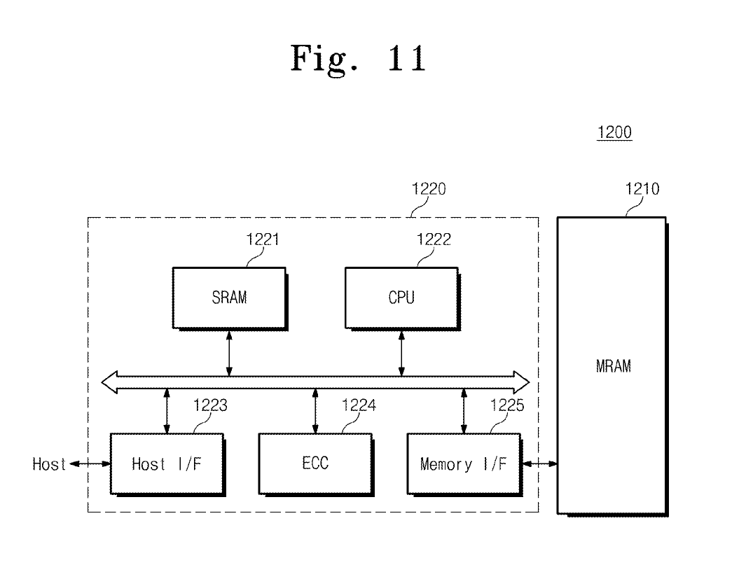

FIG. 10 is a block diagram illustrating a memory system, according to an embodiment of the inventive concept.

Referring to FIG. 10, a memory system 20 comprises a CPU 22, an SRAM 24, a memory controller 26, and a DRAM 28 which are electrically connected through a bus 21. DRAM 28 or SRAM 24 may comprise a negative bias temperature instability compensation circuit according to an embodiment of the inventive concept. In memory system 20, it is possible to prevent or reduce negative bias temperature instability effects.

N-bit data (N being an integer being 1 or more than 1) processed or to be processed by CPU 22 is stored in DRAM 28 through memory controller 26. Although not shown in FIG. 10, memory system 20 may further comprise an application chipset, a camera image processor (CIS), a mobile DRAM, etc.

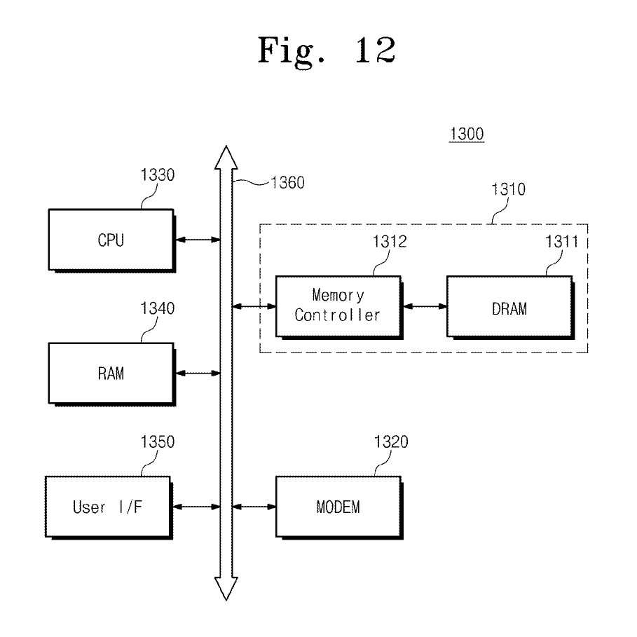

FIG. 11 is a block diagram illustrating a memory card, according to an embodiment of the inventive concept.

Referring to FIG. 11, a memory card 1200 comprises an MRAM 1210. For example, memory card 1200 comprises a memory controller 1220 that controls data exchange between a host and MRAM 1210 overall. MRAM 1210 may comprise a negative bias temperature instability compensation circuit illustrated in FIG. 3.

In memory controller 1220, an SRAM 1221 may be used as a working memory of a Central Processing Unit (CPU) 1222. A host interface 1223 may have the data exchange protocol of the host connected to memory card 1200. An ECC block 1224 may detect and correct an error in data read from MRAM 1210. A memory interface 1225 may provide an interface between MRAM 1210 and memory controller 1220. CPU 1222 may perform an overall control operation for data exchange of memory controller 1220.

MRAM 1210, as described with reference to accompanying drawings of the inventive concept, compensates for negative bias temperature instability effects, so that an operating performance of memory card 1200 is improved. FIG. 11 illustrates an embodiment in which MRAM 1210 is installed. However, a variety of nonvolatile memories may be used instead of MRAM 1210.

The nonvolatile memory may store various types of data information such as texts, graphics, software codes, and so on. The nonvolatile memory device, for example, may be implemented by Electrically Erasable Programmable Read-Only Memory (EEPROM), flash memory, Conductive bridging RAM (CBRAM), Ferroelectric RAM (FeRAM), Phase change RAM (PRAM) called Ovonic Unified Memory (OUM), RRAM or Resistive RAM (ReRAM), nanotube RRAM, Polymer RAM (PoRAM), Nano Floating Gate Memory (NFGM), holographic memory, molecular electronics memory device, or insulator resistance change memory.

FIG. 12 is a block diagram illustrating an information processing system, according to an embodiment of the inventive concept.

Referring to FIG. 12, an information processing system 1300 comprises a memory system 1310 which has a DRAM 1311. Information processing system 1300 may comprise a mobile device or a computer. For example, information processing system 1300 comprises memory system 1310, a MODEM 1320, a CPU 1330, a RAM 1340, and a user interface 1350 which are electrically connected to a system bus 1360. Data processed by CPU 1330 or data input from an external device is stored in memory system 1310.

Information processing system 1300 may further comprise a solid state disk, a camera image sensor, an application chipset, and so on. For example, memory system 1310 may be formed of a solid state drive (SSD). In this case, information processing system 1300 may store mass data in memory system 1310 stably and reliably.

DRAM 1311 that forms memory system 1310 together with a memory controller 1312 may compensate for negative bias temperature instability effects using a digital delay locked loop. Thus, a performance of information processing system 1300 is improved.

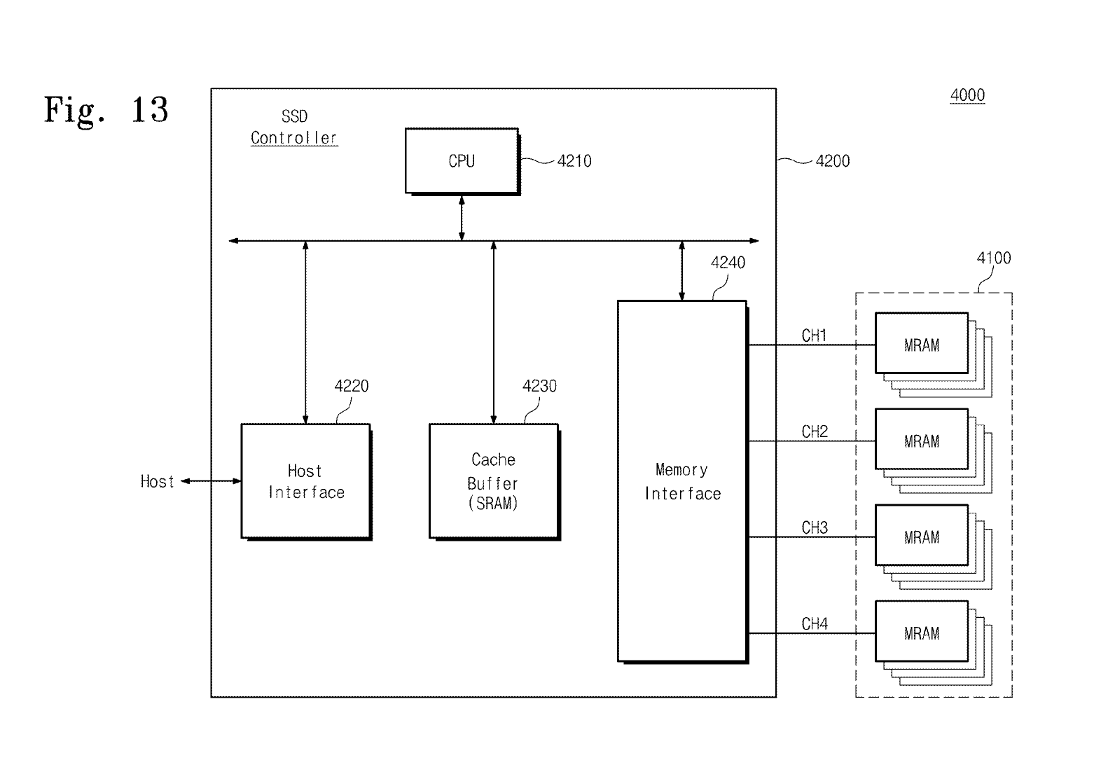

FIG. 13 is a block diagram illustrating an SSD, according to an embodiment of the inventive concept.

Referring to FIG. 13, an SSD 4000 comprises an MRAM module 4100 and an SSD controller 4200.

SSD controller 4200 controls MRAM module 4100 formed of a plurality of MRAMs. SSD controller 4200 comprises a CPU 4210, a host interface 4220, a cache buffer 4230, and a memory interface 4240.

Host interface 4220 exchanges data with a host in the ATA protocol manner under control of CPU 4210. Herein, host interface 4220 may be one of a Serial Advanced technology Attachment (SATA) interface, a Parallel Advanced Technology Attachment (PATA) interface, and an External SATA (ESATA) interface. Data input from the host through host interface 4220 or to be transferred to the host through host interface 4220 may be directly transferred to cache buffer 4230 without passing through a CPU bus under control of CPU 4210.

Cache buffer 4230 temporarily stores data transferred between an external device and MRAM module 4100. Cache buffer 4230 may be used to store programs to be executed by CPU 4210. Cache buffer 4230 may be a type of buffer memory, and it may be formed of an SRAM. In FIG. 13, there is illustrated an embodiment in which cache buffer 4230 is in SSD controller 4200. However, the inventive concept is not limited thereto. For example, cache buffer 4230 may be provided outside SSD controller 4200.

Memory interface 4240 provides an interface between MRAM module 4100 used as a storage device and SSD controller 4200. Memory interface 4240 may be configured to support a PRAM module or an RRAM module as well as MRAM module 4100.

A resistive memory cell in MRAM module 4100 or another module may be a single-level memory cell storing 1-bit data or a multi-level memory cell storing multi-bit data.

As described with reference to accompanying drawings of the inventive concept, an MRAM of MRAM module 4100 may compensate for negative bias temperature instability effects using a digital phase locked loop. Thus, an operating performance of SSD 4000 is improved.

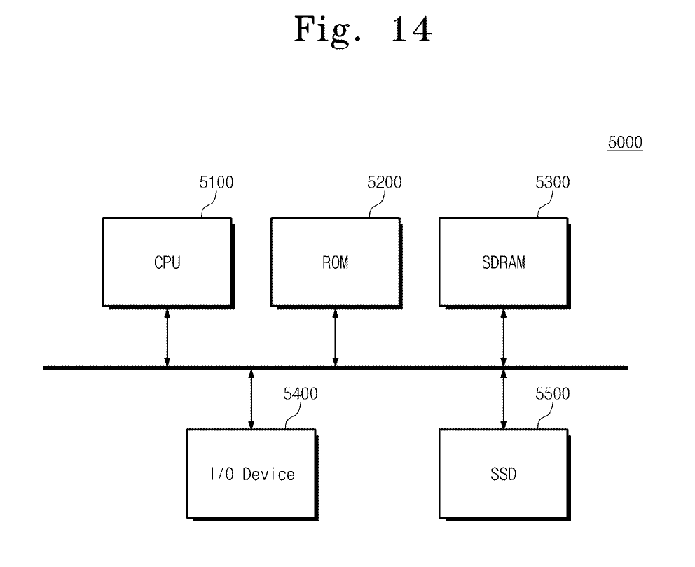

FIG. 14 is a block diagram illustrating a computing system, according to an embodiment of the inventive concept.

Referring to FIG. 14, a computing system 5000 comprises a CPU 5100, a ROM 5200, an SDRAM 5300, an input/output device 5400, and an SSD 5500.

CPU 5100 is connected to a system bus. ROM 5200 may be used to store data needed to operate computing system 5000. Such data may comprise a start command sequence, a BIOS sequence, or the like. SDRAM 5300 may temporarily store task data generated during an operation of CPU 5100. As described with reference to figures according to embodiments of the inventive concept, SDRAM 5300 may comprise a bias temperature instability compensation circuit that adaptively compensates for a bias using a DLL or a PLL.

In input/output device 5400, for example, a keyboard, a pointing device (e.g., a mouse), a monitor, a modem, etc. may be connected to a system bus through an input/output device interface. Although not illustrated in FIG. 14, computing system 5000 may further comprise an application chipset, a camera image processor (CIS), a mobile DRAM, etc. As a readable storage device, SSD 5500 may be substantially the same as that 4000 illustrated in FIG. 13.

While the inventive concept has been described with reference to certain embodiments, it will be apparent to those skilled in the art that various changes and modifications may be made to those embodiments without departing from the scope of the inventive concept. Therefore, it should be understood that the above embodiments are not limiting, but illustrative. For example, a positive bias temperature as well as a negative bias voltage may be compensated using a DLL or a PLL without departing from the scope of the inventive concept.

What is claimed is:

1. A semiconductor device, comprising:
a metal oxide semiconductor (MOS) transistor circuit configured to receive a body bias voltage; and
a negative bias temperature instability compensation (NBTIC) circuit configured to measure a negative bias temperature instability level on the MOS transistor circuit using an operating timing variation measuring unit and to adaptively compensate for a bias according to the measured value.

2. The semiconductor device of claim 1, wherein the MOS transistor circuit comprises a p-type MOS (PMOS) transistor comprising a body that receives the body bias voltage.

3. The semiconductor device of claim 1, wherein the operating timing variation measuring unit is a digital delay locked loop.

4. The semiconductor device of claim 1, wherein the operating timing variation measuring unit is a digital phase locked loop.

5. The semiconductor device of claim 1, wherein the NBTIC circuit comprises:
a first delay line configured to generate a first delay clock, driven by a reference body bias;
a second delay line configured to generate a second delay clock, driven by a feedback body bias, and being more sensitive to negative bias temperature instability than the first delay line; and
a digital delay locked loop functioning as the operating timing variation measuring unit and configured to compare a phase of the first delay clock and a phase of the second delay clock and to compensate for the body bias voltage according to the comparison result.

6. The semiconductor device of claim 5, wherein the digital delay locked loop comprises:
a phase detector configured to detect a difference between a phase of the first delay clock and a phase of the second delay clock;
an up-down counter configured to generate an up-down counting signal according to a detection output value of the phase detector; and
a body bias generator configured to generate the body bias voltage according to the up-down counting signal of the up-down counter.

7. The semiconductor device of claim 3, wherein the operating timing variation measuring unit operates during an operating period other than a normal operation of the semiconductor device.

8. The semiconductor device of claim 7, wherein the operating period other than the normal operation comprises a power-up operation period.

9. The semiconductor device of claim 5, wherein the first delay line is powered off where an operation of the operating timing variation measuring unit ends.

10. The semiconductor device of claim 9, wherein the second delay line is powered off where an operation of the operating timing variation measuring unit ends.

11. A method of compensating for negative bias temperature instability in a semiconductor device, comprising:
receiving a first delay signal from a negative bias temperature instability free delay block;
receiving a second delay signal from a negative bias temperature instability dependent delay block;
comparing the first delay signal and the second delay signal to measure a level of negative bias temperature instability; and
adaptively compensating for a body bias voltage on a transistor according to the measured level.

12. The method of claim 11, wherein the body bias voltage is a whole bias of p-type metal oxide semiconductor (PMOS) transistors or a bias of a part of a peripheral circuit.

13. The method of claim 11, wherein the body bias voltage is compensated using a digital delay locked loop.

14. The method of claim 11, wherein the body bias voltage is compensated using a digital phase locked loop.

15. The method of claim 12, wherein the body bias voltage is compensated within a power-up operation period of the semiconductor device or periodically within a normal operation period of the semiconductor device.

16. A method of compensating for negative bias temperature instability in a semiconductor device, comprising:
comparing a first delay signal to a second delay signal to measure a level of negative bias temperature instability in the semiconductor device; and
adaptively compensating for a body bias voltage of a transistor according to the measured level.

17. The method of claim 16, further comprising receiving the first delay signal from a negative bias temperature instability free delay block; and
receiving the second delay signal from a negative bias temperature instability dependent delay block.

18. The method of claim 16, wherein the transistor is a p-type metal oxide semiconductor (PMOS) transistor.

19. The method of claim 16, wherein the body bias voltage is compensated using a digital delay locked loop or a phase locked loop.

20. The method of claim 16, wherein the body bias voltage is compensated periodically within a normal operation period of the semiconductor device
